(19) United States
(12) Patent Application Publication
(10) Pub. No.: US 2026/0121303 A1
(43) Pub. Date: Apr. 30, 2026

(54) ANTENNA ELEMENT AND ARRAY ANTENNA

(71) Applicant: KYOCERA CORPORATION, Kyoto-shi, Kyoto (JP)

(72) Inventor: Hiromichi YOSHIKAWA, Yokohama-shi, Kanagawa (JP)

(21) Appl. No.: 18/835,352

(22) PCT Filed: Feb. 1, 2023
(86) PCT No.: PCT/JP2023/003240

§ 371 Date: Aug. 2, 2024

(30) Foreign Application Priority Data
Feb. 3, 2022 (JP) 2022-015910

(51) Int. Cl. H01Q 21/06

(52) U.S. Cl. CPC H01Q 21/065; H01Q 9/0414; H01Q 9/0421; H01Q 9/045; H01Q 21/0006

(57) ABSTRACT

An antenna element includes: a first conductor, a second conductor, a third conductor, and a fourth conductor; a first coupling conductor configured to capacitively couple the first conductor, the second conductor, the third conductor, and the fourth conductor; a second coupling conductor configured to capacitively couple the first conductor and the second conductor; a third coupling conductor configured to capacitively couple the second conductor and the third conductor; a fourth coupling conductor configured to capacitively couple the third conductor and the fourth conductor; a fifth coupling conductor configured to capacitively couple the fourth conductor and the first conductor; a first power feeding conductor.

### TECHNICAL FIELD

The present disclosure relates to an antenna element and an array antenna.

### BACKGROUND OF INVENTION

A technique for wirelessly transmitting power is known. For example, Patent Document 1 discloses a technique for improving transmission efficiency of a wireless power feeding system by using a resonance coil having a high Q value.

### CITATION LIST

### Patent Literature

Patent Document 1: JP 2016-10168 A

### SUMMARY

An antenna element of the present disclosure includes: a first conductor, a second conductor, a third conductor, and a fourth conductor disposed on a first surface of a base; a first coupling conductor located away from the first surface in a first direction and inside the base and configured to capacitively couple the first conductor, the second conductor, the third conductor, and the fourth conductor; a second coupling conductor located on a plane identical to a plane on which the first coupling conductor is located and configured to capacitively couple the first conductor and the second conductor; a third coupling conductor located on a plane identical to a plane on which the first coupling conductor is located and configured to capacitively couple the second conductor and the third conductor; a fourth coupling conductor located on a plane identical to a plane on which the first coupling conductor is located and configured to capacitively couple the third conductor and the fourth conductor; a fifth coupling conductor located on a plane identical to a plane on which the first coupling conductor is located and configured to capacitively couple the fourth conductor and the first conductor; a first power feeding conductor electromagnetically connected to any one of the first conductor, the second conductor, the third conductor, and the fourth conductor; and a second power feeding conductor electromagnetically connected to a conductor different from a conductor to which the first power feeding conductor is connected among the first conductor, the second conductor, the third conductor, and the fourth conductor.

An antenna element of the present disclosure includes: a first resonator, a second resonator, a third resonator, and a fourth resonator each having one end short-circuited provided circularly; a first conductor configured to capacitively couple the first resonator, the second resonator, the third resonator, and the fourth resonator in common; and a first port and a second port into which an alternating current of the same frequency is input provided in respective opposing resonators among the first resonator, the second resonator, the third resonator, and the fourth resonator. A mode is controlled by a phase difference of the alternating current of the same frequency from the first port and the second port.

An array antenna of the present disclosure includes a plurality of the antenna elements of the present disclosure.

### BRIEF DESCRIPTION OF THE DRAWINGS

FIG. 1 is a perspective view illustrating a configuration example of an antenna according to a first embodiment.

FIG. 2 is a diagram illustrating a radiation pattern in a case where a phase difference between a first input signal and a second input signal is a first phase difference according to the first embodiment.

FIG. 3 is a diagram illustrating frequency characteristics in a case where the phase difference between the first input signal and the second input signal is the first phase difference according to the first embodiment.

FIG. 4 is a diagram illustrating a radiation pattern in a case where a phase difference between the first input signal and the second input signal is a second phase difference according to the first embodiment.

FIG. 5 is a diagram illustrating frequency characteristics in a case where the phase difference between the first input signal and the second input signal is the second phase difference according to the first embodiment.

FIG. 6 is a diagram illustrating a radiation pattern in a case where a phase difference between the first input signal and the second input signal is a third phase difference according to the first embodiment.

FIG. 7 is a diagram illustrating frequency characteristics in a case where the phase difference between the first input signal and the second input signal is the third phase difference according to the first embodiment.

FIG. 8 is a diagram illustrating a radiation pattern in a case where a phase difference between the first input signal and the second input signal is a fourth phase difference according to the first embodiment.

FIG. 9 is a diagram illustrating frequency characteristics in a case where the phase difference between the first input signal and the second input signal is the fourth phase difference according to the first embodiment.

FIG. 10 is a diagram illustrating a radiation pattern in a case where a phase difference between the first input signal and the second input signal is a fifth phase difference according to the first embodiment.

FIG. 11 is a diagram illustrating frequency characteristics in a case where the phase difference between the first input signal and the second input signal is the fifth phase difference according to the first embodiment.

FIG. 12 is a diagram for explaining changes in characteristics of the antenna element according to the first embodiment.

FIG. 13 is a perspective view illustrating a configuration example of an antenna according to a second embodiment.

FIG. 14 is a diagram illustrating a configuration example of an array antenna according to a third embodiment.

### DESCRIPTION OF EMBODIMENTS

In the following, an embodiment of the present disclosure will be described in detail with reference to the accompanying drawings. Note that the present invention is not limited by this embodiment, and in the following embodiment, the same parts are denoted by the same reference numerals, and redundant description will be omitted.

In the following description, an XYZ orthogonal coordinate system is set, and the positional relationship between respective portions will be described by referring to the XYZ orthogonal coordinate system. A direction parallel to an X-axis in a horizontal plane is defined as an X-axis direction, a direction parallel to a Y-axis orthogonal to the X-axis in the horizontal plane is defined as a Y-axis direction, and a direction parallel to a Z-axis orthogonal to the horizontal plane is defined as a Z-axis direction. A plane including the X-axis and the Y-axis is appropriately referred to as an XY plane. A plane including the X-axis and the Z-axis is appropriately referred to as an XZ plane. A plane including the Y-axis and the Z-axis is appropriately referred to as a YZ plane. The XY plane is parallel to the horizontal plane. The XY plane, the XZ plane, and the YZ plane are orthogonal to each other.

### First Embodiment

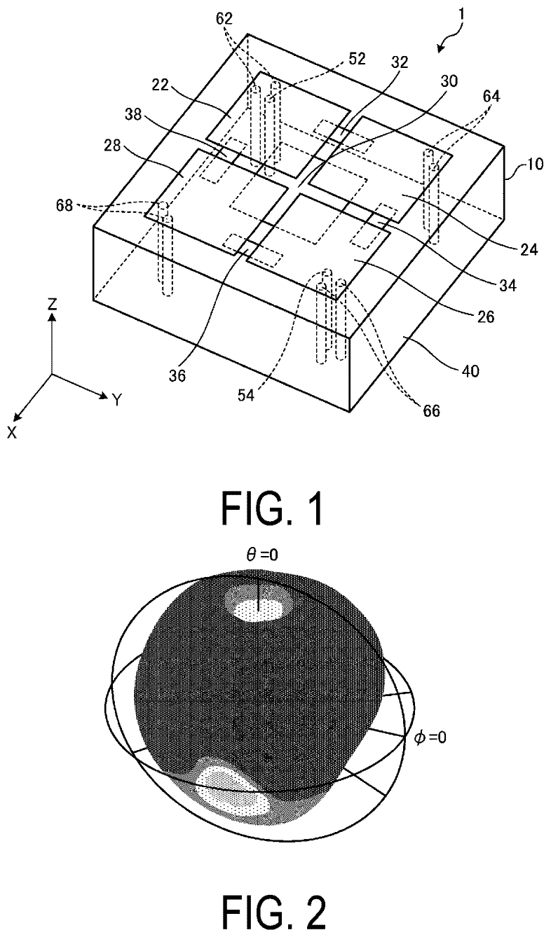

A configuration example of an antenna element according to a first embodiment will be described with reference to FIG. 1. FIG. 1 is a perspective view illustrating a configuration example of an antenna element according to a first embodiment.

As illustrated in FIG. 1, an antenna element 1 includes a base 10, a first conductor 22, a second conductor 24, a third conductor 26, a fourth conductor 28, a first coupling conductor 30, a second coupling conductor 32, a third coupling conductor 34, a fourth coupling conductor 36, a fifth coupling conductor 38, a ground conductor 40, a first power feeding conductor 52, a second power feeding conductor 54, a first connection conductor 62, a second connection conductor 64, a third connection conductor 66, and a fourth connection conductor 68.

In the present embodiment, the antenna element 1 formed in a quadrangular prism shape is described, but the present disclosure is not limited thereto. The antenna element 1 may be formed in a polygonal prism shape other than a quadrangular prism shape, a cylindrical shape, an elliptic cylinder shape, or the like.

The antenna element 1 can radiate a wave at a predetermined resonance frequency. When the antenna element 1 resonates at a predetermined resonance frequency, the antenna element 1 radiates an electromagnetic wave. The antenna element 1 can have at least one of at least one resonance frequency band of the antenna element 1 as an operation frequency. The antenna element 1 can radiate an electromagnetic wave having an operation frequency. The wavelength of the operation frequency can be an operation wavelength that is the wavelength of the electromagnetic wave at the operation frequency of the antenna element 1. On the other hand, the antenna element 1 behaves as a resonator that is a non-radiating body at the same operation frequency under the condition of signal input. In order to develop such a phenomenon, a signal condition is required under which two different modes are adjusted to have the same frequency and the two modes can be selectively excited.

The antenna element 1 exhibits, as will be described below, an artificial magnetic conductor character with respect to an electromagnetic wave having a predetermined frequency entering a surface substantially parallel to the XY plane of the antenna element 1 from the positive direction of the Z-axis. In the present disclosure, the “artificial magnetic conductor character” means a characteristic of a surface where a phase difference between an incident wave and a reflected wave at the operating frequency is 0 degrees. On the surface having the artificial magnetic conductor character, the phase difference between the incident wave and the reflected wave in the operating frequency band ranges from −90 degrees to +90 degrees. The operating frequency band includes the resonant frequency and the operating frequency that exhibit the artificial magnetic conductor character.

The base 10 is a base made of a dielectric material.

The first conductor 22, the second conductor 24, the third conductor 26, and the fourth conductor 28 are disposed on the upper surface of the base 10. The upper surface of the base 10 is also referred to as a first surface. The first conductor 22, the second conductor 24, the third conductor 26, and the fourth conductor 28 are conductors extending in the XY plane direction. The first conductor 22, the second conductor 24, the third conductor 26, and the fourth conductor 28 are configured as, for example, a square resonator. The first conductor 22, the second conductor 24, the third conductor 26, and the fourth conductor 28 are disposed in a square lattice. The first conductor 22, the second conductor 24, the third conductor 26, and the fourth conductor 28 each have a substantially equal area on the XY plane.

A gap having a predetermined interval is formed between the first conductor 22 and the second conductor 24. A gap having a predetermined interval is formed between the second conductor 24 and the third conductor 26. A gap having a predetermined interval is formed between the third conductor 26 and the fourth conductor 28. The first conductor 22 to the fourth conductor 28 are capacitively connected.

The first conductor 22, the second conductor 24, the third conductor 26, and the fourth conductor 28 formed in a square shape are described, but the present disclosure is not limited thereto. The first conductor 22, the second conductor 24, the third conductor 26, and the fourth conductor 28 may have, for example, a polygonal shape other than a square shape, a circular shape, or an elliptical shape. The first conductor 22, the second conductor 24, the third conductor 26, and the fourth conductor 28 may be different in an area and/or a shape on the XY plane.

The first coupling conductor 30, the second coupling conductor 32, the third coupling conductor 34, the fourth coupling conductor 36, and the fifth coupling conductor 38 can be located inside the base 10 away from the upper surface of the base 10 in the Z-axis direction. The Z-axis direction is also referred to as a first direction. The first coupling conductor 30, the second coupling conductor 32, the third coupling conductor 34, the fourth coupling conductor 36, and the fifth coupling conductor 38 are conductors extending in the XY plane direction.

The first coupling conductor 30 is formed in, for example, a square shape. The first coupling conductor 30 is disposed at a position away from the upper surface of the base 10 in the Z-axis direction and a position where the first coupling conductor 30 overlaps the first conductor 22, the second conductor 24, the third conductor 26, and the fourth conductor 28.

The first coupling conductor 30 capacitively connects the first conductor 22, the second conductor 24, the third conductor 26, and the fourth conductor 28. The first coupling conductor 30 formed in a square shape is described, but the present disclosure is not limited thereto. The first coupling conductor 30 may have, for example, a polygonal shape other than a square shape, a circular shape, or an elliptical shape.

The second coupling conductor 32, the third coupling conductor 34, the fourth coupling conductor 36, and the fifth coupling conductor 38 are formed in, for example, a rectangular shape. The second coupling conductor 32, the third coupling conductor 34, the fourth coupling conductor 36, and the fifth coupling conductor 38 are formed having substantially the same size. The second coupling conductor 32, the third coupling conductor 34, the fourth coupling conductor 36, and the fifth coupling conductor 38 formed in a rectangular shape are described, but the present disclosure is not limited thereto. The second coupling conductor 32, the third coupling conductor 34, the fourth coupling conductor 36, and the fifth coupling conductor 38 may have, for example, a polygonal shape other than a rectangular shape, a circular shape, or an elliptical shape.

The second coupling conductor 32 is disposed at a position away from the upper surface of the base 10 in the Z-axis direction and a position where the second coupling conductor 32 overlaps the first conductor 22 and the second conductor 24. The second coupling conductor 32 capacitively connects the first conductor 22 and the second conductor 24.

The third coupling conductor 34 is disposed at a position away from the upper surface of the base 10 in the Z-axis direction and a position where the third coupling conductor 34 overlaps the second conductor 24 and the third conductor 26. The third coupling conductor 34 capacitively connects the second conductor 24 and the third conductor 26.

The fourth coupling conductor 36 is disposed at a position away from the upper surface of the base 10 in the Z-axis direction and a position where the fourth coupling conductor 36 overlaps the third conductor 26 and the fourth conductor 28. The fourth coupling conductor 36 capacitively connects the third conductor 26 and the fourth conductor 28.

The fifth coupling conductor 38 is disposed at a position away from the upper surface of the base 10 in the Z-axis direction and a position where the fifth coupling conductor 38 overlaps the fourth conductor 28 and the first conductor 22. The fifth coupling conductor 38 capacitively connects the fourth conductor 28 and the first conductor 22.

The ground conductor 40 is disposed at the lower part of the base 10. The ground conductor 40 is disposed so as to face the first conductor 22, the second conductor 24, the third conductor 26, and the fourth conductor 28 in the Z-axis direction.

The first power feeding conductor 52 has one end electromagnetically connected to the first conductor 22 and the other end electromagnetically connected to a first power feeding point (not illustrated). The first power feeding conductor 52 can be, for example, a via formed in the base 10.

The second power feeding conductor 54 has one end electromagnetically connected to the third conductor 26 and the other end electromagnetically connected to a second power feeding point (not illustrated). The second power feeding conductor 54 can be, for example, a via formed in the base 10.

The first power feeding conductor 52 and the second power feeding conductor 54 are located on a diagonal line connecting an apex of the first conductor 22 to an apex of the third conductor 26 in the first conductor 22, the second conductor 24, the third conductor 26, and the fourth conductor 28 disposed in a square lattice.

A predetermined first input signal is input from the first power feeding conductor 52 to the first conductor 22. A predetermined second input signal is input from the second power feeding conductor 54 to the third conductor 26. The first input signal and the second input signal have the same frequency. In the present embodiment, the phase difference between the phase of the first input signal and the phase of the second input signal can be optionally changed. In the present embodiment, a resonator mode that behaves as a resonator having a relatively high Q value and an antenna mode that behaves as an antenna having a relatively low Q value can be switched by changing the phase difference between the first input signal and the second input signal.

The first connection conductor 62 has one end electromagnetically connected to the first conductor 22 and the other end electromagnetically connected to the ground conductor 40. The second connection conductor 64 has one end electromagnetically connected to the second conductor 24 and the other end electromagnetically connected to the ground conductor 40. The third connection conductor 66 has one end electromagnetically connected to the third conductor 26 and the other end electromagnetically connected to the ground conductor 40. The fourth connection conductor 68 has one end electromagnetically connected to the fourth conductor 28 and the other end electromagnetically connected to the ground conductor 40. That is, the first connection conductor 62, the second connection conductor 64, the third connection conductor 66, and the fourth connection conductor 68 surround the first conductor 22, the second conductor 24, the third conductor 26, and the fourth conductor 28.

In the present embodiment, the first connection conductors 62, the second connection conductors 64, the third connection conductors 66, and the fourth connection conductors 68 are each illustrated as two conductors, but the present disclosure is not limited thereto. The number of the first connection conductor 62, the second connection conductor 64, the third connection conductor 66, and the fourth connection conductor 68 may be one or three or more.

### Radiation Pattern

A radiation pattern of a radio wave of an antenna element according to the first embodiment will be described. In the first embodiment, the antenna element 1 can control the radiation pattern of the radio wave by controlling the phase difference between the first input signal input to the first conductor 22 and the second input signal input to the third conductor 26.

### First Phase Difference

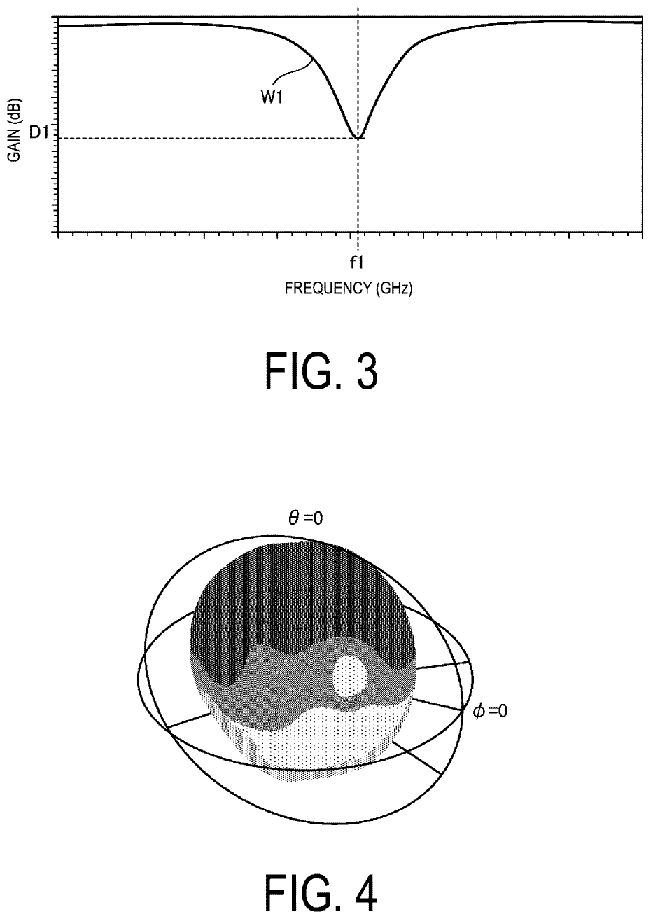

FIG. 2 is a diagram illustrating a radiation pattern in a case where the phase difference between the first input signal and the second input signal is a first phase difference according to the first embodiment. FIG. 3 is a diagram illustrating frequency characteristics in a case where the phase difference between the first input signal and the second input signal is the first phase difference according to the first embodiment. In the first embodiment, the first phase difference is 0 degrees.

When the phase difference between the first input signal and the second input signal is 0 degrees, the maximum value of the gain value of the antenna can be, for example, −22 (decibel, dBi). That is, when the phase difference between the first input signal and the second input signal is 0 degrees, no radio wave is radiated from the antenna element 1. In this case, the antenna element 1 can be in a resonator mode that behaves as a resonator. In the waveform W1 illustrated in FIG. 3, the horizontal axis represents the frequency (gigahertz, GHz), and the vertical axis represents the gain (decibel, dB) of the reflection coefficient. As illustrated in the waveform W1, when the phase difference between the first input signal and the second input signal is 0 degrees, the resonance frequency of the antenna element 1 may be f1 (GHz), and the reflection coefficient may be D1 (dB).

### Second Phase Difference

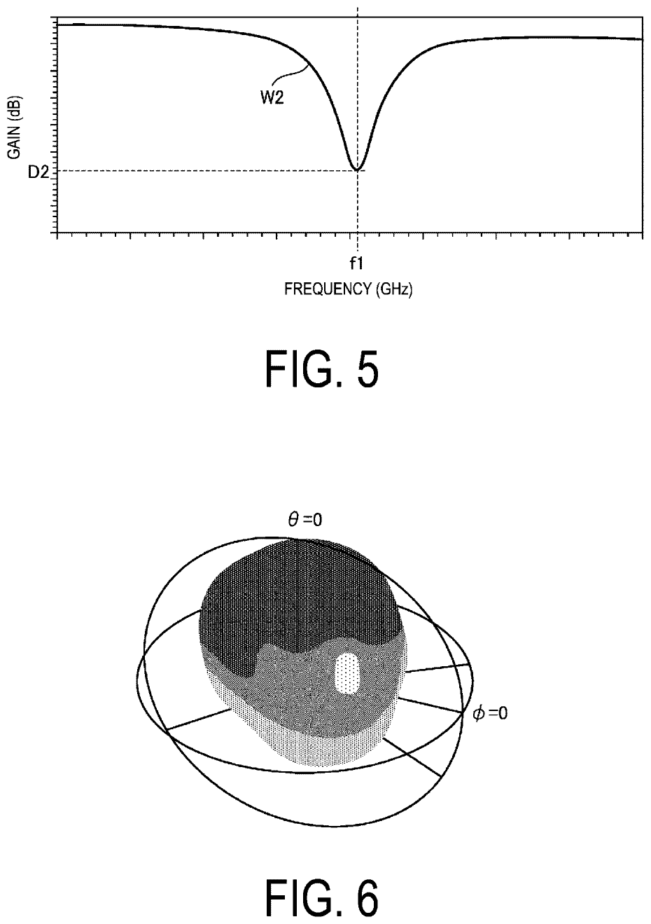

FIG. 4 is a diagram illustrating a radiation pattern in a case where the phase difference between the first input signal and the second input signal is a second phase difference according to the first embodiment. FIG. 5 is a diagram illustrating frequency characteristics in a case where the phase difference between the first input signal and the second input signal is the second phase difference according to the first embodiment. In the first embodiment, the second phase difference is 45 degrees.

When the phase difference between the first input signal and the second input signal is 0 degrees, the maximum value of the gain value of the antenna can be, for example, −9 (dBi). That is, when the phase difference between the first input signal and the second input signal is 0 degrees, radio wave is radiated from the antenna element 1. In this case, the antenna element 1 can be in an antenna mode that behaves as an antenna. In the waveform W2 illustrated in FIG. 5, the horizontal axis represents the frequency (GHz), and the vertical axis represents the gain (dB) of the reflection coefficient. As illustrated in the waveform W2, when the phase difference between the first input signal and the second input signal is 45 degrees, the resonance frequency of the antenna element 1 may be f1 (GHz), and the reflection coefficient may be D2 (dB). That is, the resonance frequency does not change between the case where the phase difference between the first input signal and the second input signal is 0 degrees and the case where the phase difference is 45 degrees. The reflection coefficient D2 is shifted to a lower side as compared with the reflection coefficient D1.

### Third Phase Difference

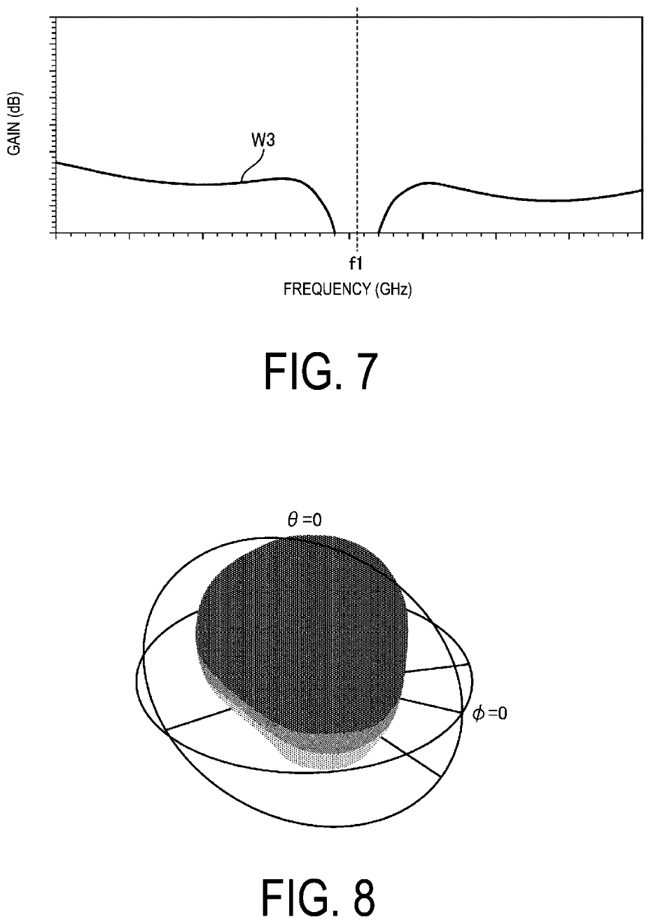

FIG. 6 is a diagram illustrating a radiation pattern in a case where the phase difference between the first input signal and the second input signal is a third phase difference according to the first embodiment. FIG. 7 is a diagram illustrating frequency characteristics in a case where the phase difference between the first input signal and the second input signal is the third phase difference according to the first embodiment. In the first embodiment, the third phase difference is 90 degrees.

When the phase difference between the first input signal and the second input signal is 0 degrees, the maximum value of the gain value of the antenna can be, for example, −3.9 (dBi). That is, when the phase difference between the first input signal and the second input signal is 0 degrees, radio wave is radiated from the antenna element 1. In this case, the antenna element 1 can be in an antenna mode that behaves as an antenna. In the waveform W3 illustrated in FIG. 7, the horizontal axis represents the frequency (GHz), and the vertical axis represents the gain (dB) of the reflection coefficient. As illustrated in the waveform W3, when the phase difference between the first input signal and the second input signal is 90 degrees, the resonance frequency of the antenna element 1 may be f1 (GHz), and the reflection coefficient may be D3 (dB) (not illustrated). That is, the resonance frequency does not change between the case where the phase difference between the first input signal and the second input signal is 0 degrees and the case where the phase difference is 90 degrees. The reflection coefficient D3 is shifted to a lower side as compared with the reflection coefficient D2.

### Fourth Phase Difference

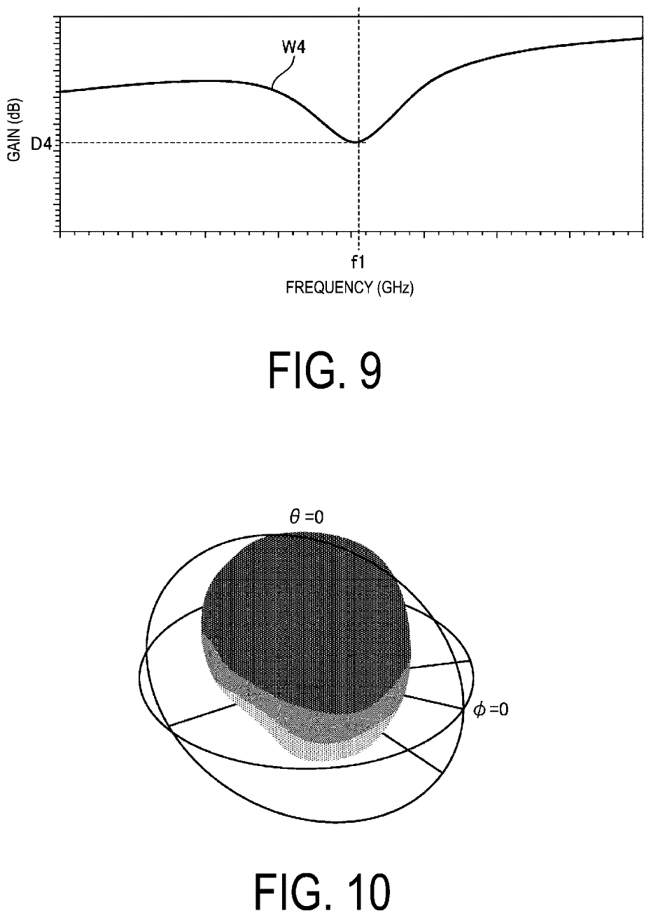

FIG. 8 is a diagram illustrating a radiation pattern in a case where the phase difference between the first input signal and the second input signal is a fourth phase difference according to the first embodiment. FIG. 9 is a diagram illustrating frequency characteristics in a case where the phase difference between the first input signal and the second input signal is the fourth phase difference according to the first embodiment. In the first embodiment, the fourth phase difference is 135 degrees.

When the phase difference between the first input signal and the second input signal is 135 degrees, the maximum value of the gain value of the antenna can be, for example, −1.7 (dBi). That is, when the phase difference between the first input signal and the second input signal is 0 degrees, radio wave is radiated from the antenna element 1. In this case, the antenna element 1 can be in an antenna mode that behaves as an antenna. In the waveform W4 illustrated in FIG. 9, the horizontal axis represents the frequency (GHz), and the vertical axis represents the gain (dB) of the reflection coefficient. As illustrated in the waveform W4, when the phase difference between the first input signal and the second input signal is 135 degrees, the resonance frequency of the antenna element 1 may be f1 (GHz), and the reflection coefficient may be D4 (dB). That is, the resonance frequency does not change between the case where the phase difference between the first input signal and the second input signal is 0 degrees and the case where the phase difference is 135 degrees. The reflection coefficient D4 is shifted to a higher side as compared with the reflection coefficient D3.

### Fifth Phase Difference

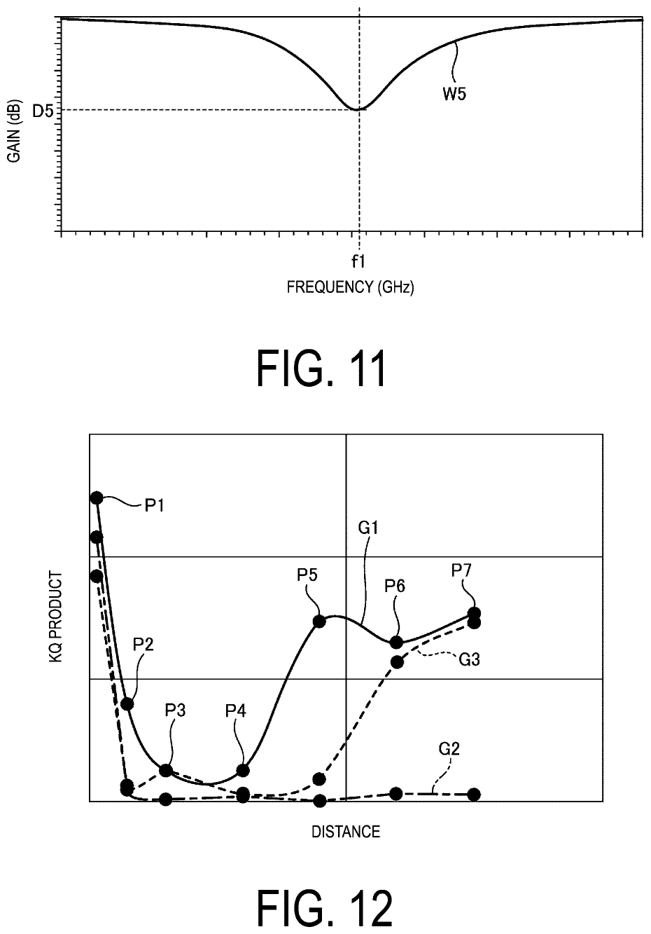

FIG. 10 is a diagram illustrating a radiation pattern in a case where the phase difference between the first input signal and the second input signal is a fifth phase difference according to the first embodiment. FIG. 11 is a diagram illustrating frequency characteristics in a case where the phase difference between the first input signal and the second input signal is the fifth phase difference according to the first embodiment. In the first embodiment, the fifth phase difference is 180 degrees.

When the phase difference between the first input signal and the second input signal is 180 degrees, the maximum value of the gain value of the antenna can be, for example, −1 (dBi). That is, when the phase difference between the first input signal and the second input signal is 0 degrees, radio wave is radiated from the antenna element 1. In this case, the antenna element 1 can be in an antenna mode that behaves as an antenna. Specifically, when the phase difference between the first input signal and the second input signal is 180 degrees, the antenna element 1 radiates linearly polarized waves. In the waveform W5 illustrated in FIG. 11, the horizontal axis represents the frequency (GHz), and the vertical axis represents the gain (dB) of the reflection coefficient. As illustrated in the waveform W5, when the phase difference between the first input signal and the second input signal is 0, the resonance frequency of the antenna element 1 may be f1 (GHz), and the reflection coefficient may be D5 (dB).

### Comparison of Characteristics

Changes in characteristics of the antenna element according to the first embodiment will be described with reference to FIG. 12. FIG. 12 is a diagram for explaining changes in characteristics of the antenna element according to the first embodiment.

In a graph G1, a graph G2, and a graph G3 illustrated in FIG. 12, the horizontal axis represents the distance (mm) from the object, and the vertical axis represents the KQ product. The graph G1 shows characteristics in a case where the phase difference between the first input signal and the second input signal is optimized in the antenna element 1 according to the first embodiment. The graph G2 shows characteristics in a case where the phase difference between the first input signal and the second input signal is 0 degrees in the antenna element 1 according to the first embodiment. The graph G3 shows characteristics in a case where the phase difference between the first input signal and the second input signal is 180 degrees in the antenna element 1 according to the first embodiment.

A point P1 indicates the KQ product of antenna elements 1 when the phase difference between the first input signal and the second input signal is 14 degrees. A point P2 indicates the KQ product of the antenna elements 1 when the phase difference between the first input signal and the second input signal is 85 degrees. A point P3 indicates the KQ product of the antenna elements 1 when the phase difference between the first input signal and the second input signal is 172 degrees. A point P4 indicates the KQ product of the antenna elements 1 when the phase difference between the first input signal and the second input signal is 135 degrees. A point P5 indicates the KQ product of the antenna elements 1 when the phase difference between the first input signal and the second input signal is 121 degrees. A point P6 indicates the KQ product of the antenna elements 1 when the phase difference between the first input signal and the second input signal is 180 degrees. A point P7 indicates the KQ product of the antenna elements 1 when the phase difference between the first input signal and the second input signal is 171 degrees.

The graph G1 indicates a KQ product relatively close to the graph G2 at a place where the distance to the object is short. That is, the antenna element 1 can be adjusted to function as a resonator at a place where the distance to the object is short. The graph G1 indicates a KQ product relatively close to the graph G3 at a place where the distance to the object is long. That is, the antenna element 1 can be adjusted to function as an antenna at a place where the distance to the object is long.

In addition, the graph G1 shows a KQ product relatively higher than those of the graphs G2 and G3 from a place where the distance to the object is short to a place where the distance is long. That is, the antenna element 1 can realize a relatively high KQ product regardless of the distance to the object.

As described above, in the first embodiment, a relatively high KQ product can be realized from a place where the distance to the object is short to a place where the distance is long by controlling the phase difference between the first input signal and the second input signal input to the antenna element 1. As a result, the first embodiment can obtain high transmission efficiency from a place where the distance to the object is short to a place where the distance to the object is long.

### Second Embodiment

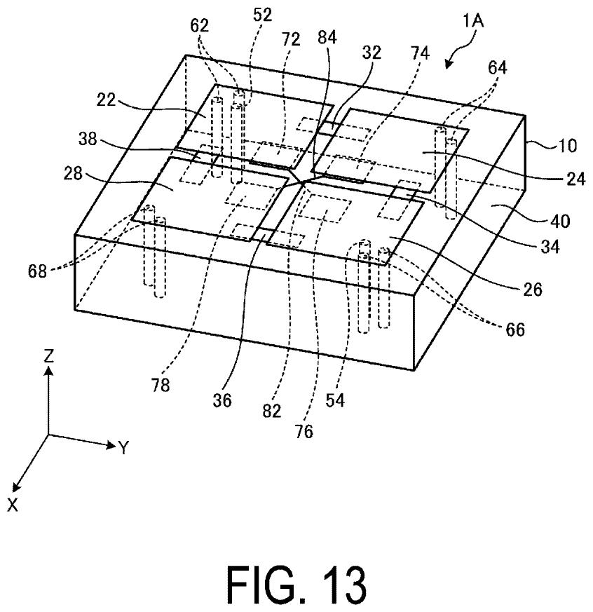

A configuration example of the antenna according to a second embodiment will be described with reference to FIG. 13. FIG. 13 is a perspective view illustrating a configuration example of an antenna according to the second embodiment.

As illustrated in FIG. 13, an antenna element 1A is different from the antenna element 1 illustrated in FIG. 1 in that the antenna element 1A does not include the first coupling conductor 30 and includes a sixth coupling conductor 72, a seventh coupling conductor 74, an eighth coupling conductor 76, a ninth coupling conductor 78, a first connecting portion 82, and a second connecting portion 84.

The sixth coupling conductor 72, the seventh coupling conductor 74, the eighth coupling conductor 76, and the ninth coupling conductor 78 can be located inside the base 10 away from the upper surface of the base 10 in the Z-axis direction. The sixth coupling conductor 72, the seventh coupling conductor 74, the eighth coupling conductor 76, and the ninth coupling conductor 78 are formed on the same plane inside the base 10. The sixth coupling conductor 72, the seventh coupling conductor 74, the eighth coupling conductor 76, and the ninth coupling conductor 78 are formed to, for example, a square shape. The sixth coupling conductor 72, the seventh coupling conductor 74, the eighth coupling conductor 76, and the ninth coupling conductor 78 are formed to substantially the same shape. The sixth coupling conductor 72, the seventh coupling conductor 74, the eighth coupling conductor 76, and the ninth coupling conductor 78 are smaller than the first conductor 22, the second conductor 24, the third conductor 26, and the fourth conductor 28, respectively. The sixth coupling conductor 72, the seventh coupling conductor 74, the eighth coupling conductor 76, and the ninth coupling conductor 78 formed in a square shape are described, but the present disclosure is not limited thereto. The sixth coupling conductor 72, the seventh coupling conductor 74, the eighth coupling conductor 76, and the ninth coupling conductor 78 may have, for example, a polygonal shape other than a square shape, a circular shape, or an elliptical shape.

The sixth coupling conductor 72 is disposed at a position away from the upper surface of the base 10 in the Z-axis direction with at least part of the ninth coupling conductor 72 overlapping the first conductor 22.

The seventh coupling conductor 74 is disposed at a position away from the upper surface of the base 10 in the Z-axis direction with at least part of the ninth coupling conductor 74 overlapping the second conductor 24.

The eighth coupling conductor 76 is disposed at a position away from the upper surface of the base 10 in the Z-axis direction with at least part of the ninth coupling conductor 76 overlapping the third conductor 26.

The ninth coupling conductor 78 is disposed at a position away from the upper surface of the base 10 in the Z-axis direction with at least part of the ninth coupling conductor 78 overlapping the fourth conductor 28.

The first connecting portion 82 electromagnetically connects the sixth coupling conductor 72 and the eighth coupling conductor 76. The first connecting portion 82 has one end electromagnetically connected to a vertex of the sixth coupling conductor 72 facing the eighth coupling conductor 76 and the other end electromagnetically connected to a vertex of the eighth coupling conductor 76 facing the sixth coupling conductor 72.

The second connecting portion 84 electromagnetically connects the seventh coupling conductor 74 and the ninth coupling conductor 78. The second connecting portion 84 has one end electromagnetically connected to a vertex of the seventh coupling conductor 74 facing the ninth coupling conductor 78 and the other end electromagnetically connected to a vertex of the ninth coupling conductor 78 facing the seventh coupling conductor 74.

The first connecting portion 82 and the second connecting portion 84 are electromagnetically connected. The first connecting portion 82 and the second connecting portion 84 are electromagnetically connected at an intersection of a straight line connecting the sixth coupling conductor 72 and the eighth coupling conductor 76 and a straight line connecting the seventh coupling conductor 74 and the ninth coupling conductor 78.

The sixth coupling conductor 72, the seventh coupling conductor 74, the eighth coupling conductor 76, the ninth coupling conductor 78, the first connecting portion 82, and the second connecting portion 84 are configured to capacitively connect the first conductor 22, the second conductor 24, the third conductor 26, and the fourth conductor 28.

When manufacturing the antenna element 1A, for example, it is assumed that variations will occur in relative positions of the first conductor 22 to the fourth conductor 28 and the sixth coupling conductor 72 to the ninth coupling conductor 78. If the positions of the sixth coupling conductor 72 to the ninth coupling conductor 78 are shifted with respect to the first conductor 22 to the fourth conductor 28, it is also assumed that the magnitude of capacitive coupling will change and the characteristics of the antenna element 1A will be affected. Here, the sixth coupling conductor 72 to the ninth coupling conductor 78 are smaller than the first conductor 22 to the fourth conductor 28, respectively. Therefore, when manufacturing the antenna element 1A, it is relatively easy to manufacture the antenna element 1A such that portions where the sixth coupling conductor 72 to the ninth coupling conductor 78 do not overlap the first conductor 22 to the fourth conductor 28 are reduced in size. That is, in the second embodiment, the variations in the magnitude of the capacitive coupling between the first conductor 22 to the fourth conductor 28 and the sixth coupling conductor 72 to the ninth coupling conductor 78 can be reduced, so that the variation in the characteristics of the antenna element 1A can be reduced.

As described above, in the second embodiment, the first conductor 22 to the fourth conductor 28 are capacitively coupled by the sixth coupling conductor 72 to the ninth coupling conductor 78, whereby the variation in the characteristics of the antenna element 1A can be reduced. Thus, in the second embodiment, the characteristics of the antenna element 1A can be stabilized.

### Third Embodiment

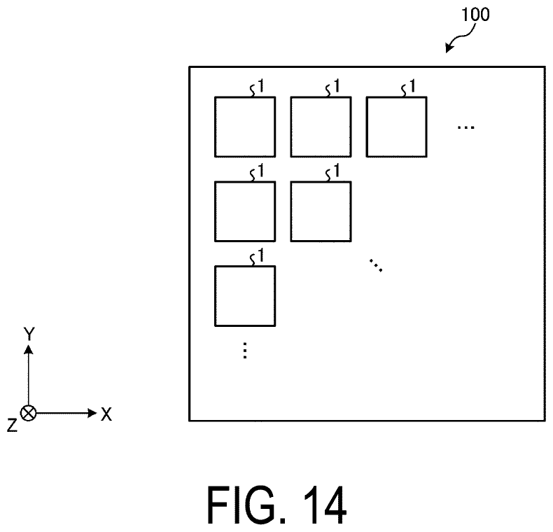

A third embodiment of the present disclosure will be described. FIG. 14 is a diagram illustrating a configuration example of an array antenna according to the third embodiment.

As illustrated in FIG. 14, the array antenna 100 includes a plurality of antenna elements 1. The plurality of antenna elements 1 are, for example, disposed at predetermined intervals along the X axis and the Y axis. For example, the plurality of antenna elements 1 may be disposed at equal intervals or may be disposed at non-equal intervals along the X axis and the Y axis. The plurality of antenna elements 1 may be disposed at equal intervals or non-equal intervals along the oblique direction on the XY plane.

Embodiments of the present disclosure have been described above, but the present disclosure is not limited by the contents of the embodiments. Constituent elements described above include those that can be easily assumed by a person skilled in the art, those that are substantially identical to the constituent elements, and those within a so-called range of equivalency. The constituent elements described above can be combined as appropriate. Various omissions, substitutions, or modifications of the constituent elements can be made without departing from the spirit of the above-described embodiments.

### REFERENCE SIGNS

1, 1A Antenna element (resonance element)
10 Base
22 First conductor
24 Second conductor
26 Third conductor
28 Fourth conductor
30 First coupling conductor
32 Second coupling conductor
34 Third coupling conductor
36 Fourth coupling conductor
38 Fifth coupling conductor
40 Ground conductor
52 First power feeding conductor
54 Second power feeding conductor
62 First connection conductor
64 Second connection conductor
66 Third connection conductor
68 Fourth connection conductor
72 Sixth coupling conductor
74 Seventh coupling conductor
76 Eighth coupling conductor
78 Ninth coupling conductor
82 First connecting portion
84 Second connecting portion
100 Array antenna

1. An antenna element, comprising:
a first conductor, a second conductor, a third conductor, and a fourth conductor disposed on a first surface of a base;
a first coupling conductor located away from the first surface in a first direction and inside the base and configured to capacitively couple the first conductor, the second conductor, the third conductor, and the fourth conductor;
a second coupling conductor located on a plane identical to a plane on which the first coupling conductor is located and configured to capacitively couple the first conductor and the second conductor;
a third coupling conductor located on a plane identical to a plane on which the first coupling conductor is located and configured to capacitively couple the second conductor and the third conductor;
a fourth coupling conductor located on a plane identical to a plane on which the first coupling conductor is located and configured to capacitively couple the third conductor and the fourth conductor;
a fifth coupling conductor located on a plane identical to a plane on which the first coupling conductor is located and configured to capacitively couple the fourth conductor and the first conductor;
a first power feeding conductor electromagnetically connected to any one of the first conductor, the second conductor, the third conductor, and the fourth conductor; and
a second power feeding conductor electromagnetically connected to a conductor different from a conductor to which the first power feeding conductor is connected among the first conductor, the second conductor, the third conductor, and the fourth conductor.

2. The antenna element according to claim 1,
wherein the first conductor, the second conductor, the third conductor, and the fourth conductor are disposed in a square lattice,
the second coupling conductor is disposed overlapping the first conductor and the second conductor at a position away in the first direction,
the third coupling conductor is disposed overlapping the second conductor and the third conductor at a position away in the first direction,
the fourth coupling conductor is disposed overlapping the third conductor and the fourth conductor at a position away in the first direction, and
the fifth coupling conductor is disposed overlapping the fourth conductor and the first conductor at a position away in the first direction.

3. The antenna element according to claim 2, wherein the first power feeding conductor and the second power feeding conductor are located on a diagonal line of the square lattice.

4. The antenna element according to claim 1, wherein the first coupling conductor is disposed overlapping the first conductor, the second conductor, the third conductor, and the fourth conductor at a position away in the first direction.

5. The antenna element according to claim 1,
wherein the first coupling conductor comprises a sixth coupling conductor, a seventh coupling conductor, an eighth coupling conductor, a ninth coupling conductor, a first connecting portion electromagnetically connecting the sixth coupling conductor and the eighth coupling conductor, and a second connecting portion electromagnetically connecting the seventh coupling conductor and the ninth coupling conductor,
the sixth coupling conductor is disposed at a position away in the first direction with at least part thereof overlapping the first conductor,
the seventh coupling conductor is disposed at a position away in the first direction with at least part thereof overlapping the second conductor,
the eighth coupling conductor is disposed at a position away in the first direction with at least part thereof overlapping the third conductor,
the ninth coupling conductor is disposed at a position away in the first direction with at least part thereof overlapping the fourth conductor, and
the first connecting portion and the second connecting portion are electromagnetically connected.

6. An antenna element, comprising:
a first resonator, a second resonator, a third resonator, and a fourth resonator each having one end short-circuited provided circularly;
a first conductor configured to capacitively couple the first resonator, the second resonator, the third resonator, and the fourth resonator in common; and
a first port and a second port into which an alternating current of the same frequency is input provided in respective opposing resonators among the first resonator, the second resonator, the third resonator, and the fourth resonator,
wherein a mode is controlled by a phase difference of the alternating current of the same frequency from the first port and the second port.

7. An array antenna comprising a plurality of the antenna elements according to claim 1.
